(19) United States
(12) Patent Application Publication
(10) Pub. No.: US 2018/0009979 A1
(43) Pub. Date: Jan. 11, 2018

(54) RESIN COMPOSITION, RESIN SHEET, AND CURED RESIN MATERIAL AND METHOD FOR PRODUCING THE SAME

(71) Applicant: HITACHI CHEMICAL COMPANY. LTD., Tokyo (JP)

(72) Inventors: Tomoo NISHIYAMA, Tsukuba-shi (JP); Haruaki SUE, Chikusei-shi (JP); Hideyuki KATAGI, Tsukuba-shi (JP); Naoki HARA, Hitachi-shi (JP); Hiroyuki TAKAHASHI, Tsukuba-shi (JP); Yasuo MIYAZAKI, Tsukuba-shi (JP); Yoshitaka TAKEZAWA, Tsukuba-shi (JP); Hiroyuki TANAKA, Hitachi-shi (JP); Kensuke YOSHIHARA, Hitachi-shi (JP); Masayoshi JOUMEN, Chikusei-shi (JP)

(21) Appl. No.: 15/710,597

(22) Filed: Sep. 20, 2017

Related U.S. Application Data
(62) Division of application No. 13/498,278, filed on Jun. 7, 2012, now abandoned.

(30) Foreign Application Priority Data
Sep. 29, 2009 (JP) 2009-224333
Mar. 25, 2010 (JP) 2010-071002

(51) Int. Cl. C08L 63/08; C08L 61/12; C08G 59/62; B32B 27/26; B32B 27/38; C08L 63/00; B32B 15/08; C08L 61/06; C08K 3/22

(52) U.S. Cl. CPC C08L 63/08; C08L 63/00; C08L 61/12; C08G 59/621; B32B 15/08; B32B 27/26; B32B 27/38; Y10T 428/31529; Y10T 156/10; C08K 3/22; C08K 2003/2227; C08L 61/06

(57) ABSTRACT

A resin composition constituted by containing an epoxy resin monomer having a mesogenic structure, a novolac resin containing a compound having a structural unit represented by the following general formula (I), and an inorganic filler is superior in preservation stability before curing, and can attain high thermal conductivity after curing.

In the following general formula (I), R¹, R² and R³ independently represent a hydrogen atom, an alkyl group, an aryl group, or an aralkyl group; m represents an integer of 0 to 2; and n an integer of 1 to 7.

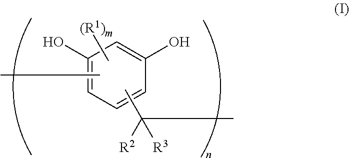

### TECHNICAL FIELD

The present invention relates to a resin composition, a resin sheet, and a cured resin material and a method for producing the same.

### BACKGROUND ART

In step with progress of the movement toward smaller size, larger capacity and higher performance of an electronic device using a semiconductor, a heat generation value from a semiconductor mounted at a higher density has been growing more and more. For example, for stable operation of a central processing unit of a personal computer or a semiconductor device used for controlling an electrical car motor, a heat sink or a radiation fin is indispensable for radiating heat, and a material having both insulating and thermally conductive abilities as a component for connecting a semiconductor device and a heat sink, and the like has been expected.

Generally, as an insulating material for a printed substrate and the like, on which a semiconductor device and the like are mounted, an organic material is broadly used. However, such an organic material has good insulation but poor thermal conductivity, and its contribution for radiating heat of a semiconductor device has been not sufficient. While, in some cases an inorganic material such as an inorganic ceramic is used for radiating heat of a semiconductor device, and the like. Such an inorganic material has high thermal conductivity, but its insulation is not sufficient compared to an organic material, and a material having compatibly both insulating and thermally conductive abilities has been wanted.

In connection with the above, a technique for providing a cured thermosetting resin with superior thermal conductivity as a material having compatibly both insulating and thermally conductive abilities is described in Japanese Patent No. 4118691. According thereto, higher thermal conductivity is attained for by forming a structure with microscopic alignment in a resin, and the thermal conductivity is 0.69 to 1.05 W/mK as measured by a plate comparison method (steady state method).

Further, many studies are under way about a composite material of a resin and an inorganic filling material (called as “filler”) with high thermal conductivity. For example, Japanese Patent Laid-Open No. 2008-13759 discloses a cured material of a composite of a general bisphenol A epoxy resin and an alumina filler, and states that as the resulted thermal conductivity 3.8 W/mK according to the xenon flash lamp method, or 4.5 W/mK according to the temperature wave analysis is attainable. Similarly, a cured material of a composite composed of a special epoxy resin, an amine curing agent, and alumina is known, and it is reported that the thermal conductivity of 9.4 W/mK according to the xenon flash lamp method or 10.4 W/mK according to the temperature wave analysis is attainable.

### DISCLOSURE OF INVENTION

### Problem to be Solved by the Invention

However, concerning the cured material described in Japanese Patent No. 4118691, thermal conductivity sufficient for practical use has not been obtained. Concerning the cured material described in Japanese Patent Application Laid-Open No. 2008-13759, the usable life of a resin composition before curing is short, and the preservation stability is not sufficient by any means.

A object of the present invention is to provide a resin composition, which is superior in preservation stability before curing, and can attain high thermal conductivity after curing; a resin sheet containing the resin composition; a cured resin material obtained by curing the resin composition and a method for producing the same; and a resin sheet laminate and a method for producing the same.

### Means for Solving the Problem

A 1st aspect of the present invention is a resin composition including an epoxy resin monomer having a mesogenic group, a novolac resin containing a compound having a structural unit represented by the following general formula (I), and an inorganic filler.

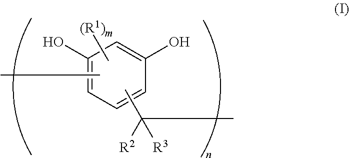

In the general formula (I), R¹ represents a hydrogen atom, an alkyl group, an aryl group, or an aralkyl group; each of R² and R³ independently represents a hydrogen atom, an alkyl group, an aryl group, or an aralkyl group; m represents an integer from 0 to 2; and n represents an integer from 1 to 7.

The monomer content of the novolac resin is preferably from 5% by mass to 80% by mass. Further, the epoxy resin monomer is preferably represented by the following general formula (II).

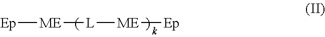

In general formula (II), Ep represents a group including an epoxy group; ME represents a mesogenic group; L represents a bivalent linking group; and k represents 0 or 1.

The resin composition preferably further includes a coupling agent.

A 2nd aspect of the present invention is a resin sheet derived from the resin composition.

A 3rd aspect of the present invention is a cured resin material obtained by curing the resin composition.

Further, a 4th aspect of the present invention is a method for producing a cured resin material including heating the resin composition in a temperature range of from 70° C. to 200° C.

A 5th aspect of the present invention is a resin sheet laminate including a cured resin sheet obtained by curing the resin sheet, and a metal plate or a radiator plate placed on at least one surface of the cured resin sheet.

Further, a 5th aspect of the present invention is a method for producing a resin sheet laminate including preparing a laminate by placing a metal plate or a radiator plate on at least one surface of the resin sheet, and heating the laminate in a temperature range of from 70° C. to 200° C.

### Effects of the Invention

According to the present invention, a resin composition, which is superior in preservation stability before curing, and can attain high thermal conductivity after curing; a resin sheet containing the resin composition; a cured resin material obtained by curing the resin composition; and a method for producing the same; and a resin sheet laminate; and a method for producing the same can be provided.

### BRIEF DESCRIPTION OF DRAWINGS

FIG. 1 is a schematic cross-sectional view showing an example of a constitution of a power semiconductor device constituted with a resin sheet according to the present invention.

FIG. 2 is a schematic cross-sectional view showing an example of a constitution of a power semiconductor device constituted with a resin sheet according to the present invention.

FIG. 3 is a schematic cross-sectional view showing an example of a constitution of a power semiconductor device constituted with a resin sheet according to the present invention.

FIG. 4 is a schematic cross-sectional view showing an example of a constitution of an LED light bar constituted with a resin sheet according to the present invention.

FIG. 5 is a schematic cross-sectional view showing an example of a constitution of an LED bulb constituted with a resin sheet according to the present invention.

FIG. 6 is a schematic cross-sectional view showing an example of a constitution of an LED bulb constituted with a resin sheet according to the present invention.

FIG. 7 is a schematic cross-sectional view showing an example of a constitution of an LED substrate constituted with a resin sheet according to the present invention.

### BEST MODE FOR CARRYING OUT THE INVENTION

Herein a numerical represention of “A to B” shall mean a range inclusive of the minimum value and the maximum value A and B respectively.

<Resin Composition>

A resin composition according to the present invention is a resin composition including an epoxy resin monomer having a mesogenic group, a novolac resin containing a compound having a structural unit represented by the following general formula (I), and an inorganic filler.

Owing to such a constitution, an insulating cured resin material, which is superior in preservation stability before curing, has a sufficient usable life and superior adhesiveness, and further is superior in thermal conductivity, can be formed.

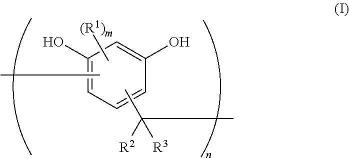

In the general formula (I), R¹ represents a hydrogen atom, an alkyl group, an aryl group, or an aralkyl group; R² and R³ independently represent a hydrogen atom, an alkyl group, an aryl group, or an aralkyl group; m represents an integer of 0 to 2; and n represents an integer of 1 to 7.

(Novolac Resin)

A resin composition according to the present invention contains a novolac resin containing at least one compound having a structural unit represented by the above general formula (I).

In the above general formula (I), R¹ represents a hydrogen atom, an alkyl group, an aryl group, or an aralkyl group. An alkyl group, an aryl group, and an aralkyl group represented by R¹ may, if possible, further have a substituent. Examples of the substituent include an alkyl group, an aryl group, a halogen atom, and a hydroxy group.

The m represents an integer of 0 to 2, and if m is 2, two R¹ may be the same or different. According to the present invention, m is preferably 0 or 1, and more preferably 0.

A novolac resin according to the present invention is required to contain at least one compound having a structural unit represented by the general formula (I), and may contain 2 or more compounds having a structural unit represented by the general formula (I).

A novolac resin according to the present invention contains a moiety derived from resorcinol as a phenolic compound, and it may further contain at least one moiety derived from a phenolic compound other than resorcinol. Examples of a phenolic compound other than resorcinol include phenol, cresol, catechol, and hydroquinone. The novolac resin may contain moieties derived therefrom singly or in a combination of 2 or more types.

In this regard, a moiety derived from a phenolic compound means a monovalent or bivalent group constituted by removing 1 or 2 hydrogen atom(s) from a benzene ring of a phenolic compound. In this connection, there is no particular restriction on the position of hydrogen atom removal.

According to the present invention, from aspects of thermal conductivity, adhesiveness, and preservation stability, a moiety derived from a phenolic compound other than resorcinol is preferably a moiety derived from at least one selected out of phenol, cresol, catechol, hydroquinone, 1,2,3-trihydroxybenzene, 1,2,4-trihydroxybenzene, and 1,3,5-trihydroxybenzene, and more preferably a moiety derived from at least one selected out of catechol and hydroquinone.

There is no particular restriction on the content percentage of a moiety derived from resorcinol in the novolac resin. From an aspect of elasticity modulus, the content percentage of a moiety derived from resorcinol based on the total mass of the novolac resin is preferably 55% by mass or more. Further, from aspects of glass transition temperature and linear expansion coefficient, it is more preferably 80% by mass or more. Further, from an aspect of thermal conductivity, it is further preferably 90% by mass or more.

In the general formula (I), R² and R³ independently represent a hydrogen atom, an alkyl group, an aryl group, a phenyl group, or an aralkyl group. An alkyl group, a phenyl group, an aryl group, and an aralkyl group represented by R² and R³ may, if possible, further have a substituent. Examples of the substituent include an alkyl group, an aryl group, a halogen atom, and a hydroxy group.

From aspects of preservation stability and thermal conductivity, R² and R³ according to the present invention are preferably a hydrogen atom, an alkyl group, a phenyl group or an aryl group; more preferably a hydrogen atom, a alkyl group having carbon atoms 1 to 4, or an aryl group having carbon atoms 3 to 6 or phenyl group; and further preferably a hydrogen atom.

Further, from an aspect of thermal stability, it is also preferable that at least one of R² and R³ is an aryl group.

As a novolac resin according to the present invention is preferable specifically a novolac resin containing a compound having a moiety represented by any one of the general formula (Ia) to the general formula (If) shown below.

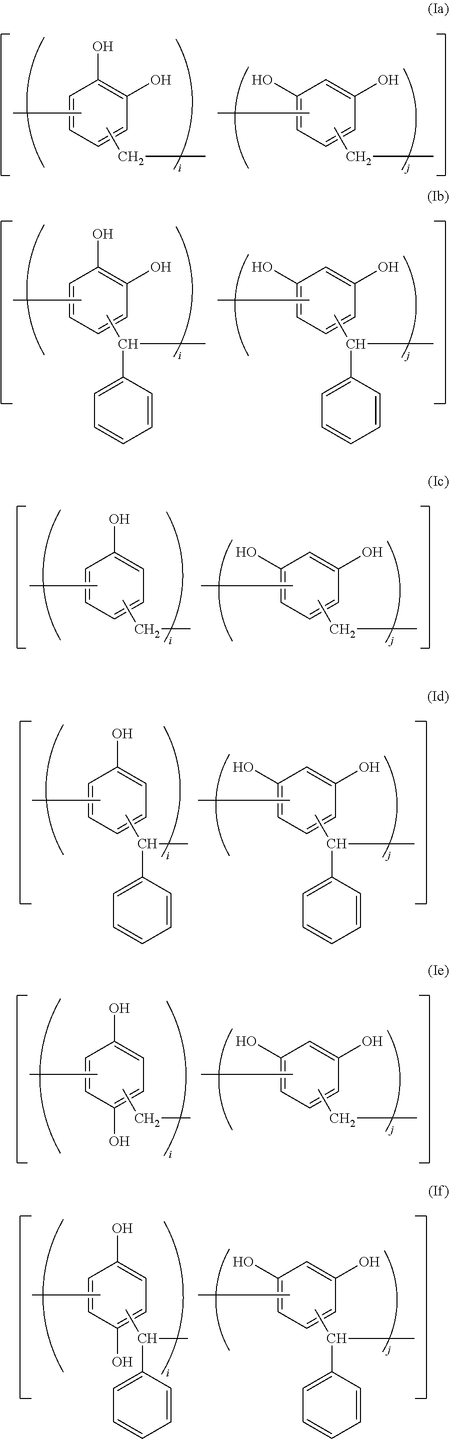

In the general formula (Ia) to the general formula (If), i and j each represents the content (% by mass) of a structural unit derived from a phenolic compound, wherein i is 5 to 30% by mass, and j is 70 to 95% by mass, and the total of i and j is 100% by mass.

A novolac resin according to the present invention contains preferably, from an aspect of thermal conductivity, a structural unit represented by either of the general formula (Ia) and the general formula (Ie), wherein i is 5 to 20% by mass and j is 80 to 95% by mass; and from aspects of coefficient of elasticity and linear expansion coefficient contains more preferably a structural unit represented by the general formula (Ia), wherein i is 2 to 10% by mass and j is 90 to 98% by mass.

A novolac resin according to the present invention contains a compound having a structural unit represented by the above general formula (I), and it should preferably contain at least one compound represented by the following general formula (III).

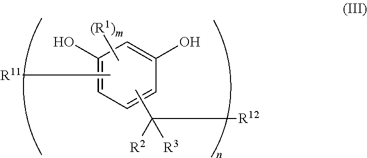

In the general formula (III), R¹¹ represents a hydrogen atom or a monovalent group derived from a phenolic compound represented by the following general formula (IIIp), and R¹² represents a monovalent group derived from a phenolic compound. While, R¹, R², R³, m and n have the same meanings as the R¹, R², R³, m and n in the general formula (I).

A monovalent group derived from a phenolic compound represented by R¹² is a monovalent group constituted by removing a hydrogen atom from a benzene ring of a phenolic compound, and there is no particular restriction on the position of hydrogen atom removal.

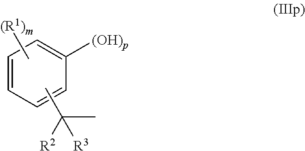

In the general formula (IIIp), p represents an integer of 1 to 3. While, R¹, R², R³, and m have the same meanings as the R¹, R², R³, and m in the general formula (I).

There is no particular restriction on a phenolic compound for R¹¹ and R¹², insofar as it is a compound having a phenolic hydroxy group. Specific examples thereof include phenol, cresol, catechol, resorcinol, and hydroquinone. Among them, from aspects of thermal conductivity and preservation stability, at least one selected from cresol, catechol, and resorcinol is preferable.

The number average molecular weight of the novolac resin is, from an aspect of thermal conductivity, preferably 800 or less. While, from aspects of coefficient of elasticity and linear expansion coefficient, more preferably it is 300 to 700. Further, from aspects of formability and adhesive strength, more preferably it is 350 to 550.

With respect to a resin composition according to the present invention, a novolac resin containing a compound having a structural unit represented by the above general formula (I) may contain a monomer, which is a phenolic compound constituting a novolac resin. There is no particular restriction on the content percentage of a monomer, which is a phenolic compound constituting a novolac resin (hereinafter occasionally referred to as “monomer content”). From an aspect of thermal conductivity it is preferably 5 to 80% by mass, from an aspect of coefficient of elasticity more preferably 15 to 60% by mass, and from aspects of formability and adhesive strength further preferably 20 to 50% by mass.

If the monomer content is 80% by mass or less, the monomer, which does not contribute to cross-linking on the occasion of curing, decreases, and the amount of a cross-linkable higher molecular weight substance increases; and the thermal conductivity improves owing to formation of higher order structures at a higher density. If it is 5% by mass or higher, the flowability on the occasion of forming becomes better, and the adherence with an inorganic filler improves, so that better thermal conductivity and thermal stability can be attained. If it is 60% by mass or less, the cross-link density increases and the coefficient of elasticity improves; while if it is 15% by mass or more, generation of a defect in a formed resin article is suppressed, so that the structure becomes denser and the coefficient of elasticity improves. Further, if it is 50% by mass or less, the cross-link density increases further, the elasticity modulus improves, and the adhesive strength improves. Further, if it is 20% by mass or more, the resin formability is maintained, and the surface of an adherend substrate can be wetted by a resin owing to the resin flowability on the occasion of adhesion, so that the adhesive strength to the adherend improves.

Examples of a monomer of a phenolic compound constituting a novolac resin can include resorcinol, catechol and hydroquinone, and preferably at least resorcinol is contained as a monomer.

With respect to a resin composition according to the present invention, there is no particular restriction on the content percentage of the novolac resin. From aspects of thermal conductivity and preservation stability, it is preferably 1 to 10% by mass, and more preferably 2 to 8% by mass.

(Epoxy Resin Monomer)

A resin composition according to the present invention contains at least one epoxy resin monomer having a mesogenic group. By constituting a cured resin material with such an epoxy resin monomer and the novolac resin, high thermal conductivity can be attained. This can be explained, for example, as follows. As the result of forming a cured resin material by curing an epoxy resin monomer having a mesogenic group in the molecule using the novolac resin as a curing agent, a higher order structure derived from the mesogenic group can be formed in the cured resin material, through which high thermal conductivity can be seemingly attained.

In this connection, a higher order structure means a state, in which molecules align after curing a resin composition, and, for example, a crystalline structure and a liquid crystalline structure exist in a cured resin material. The existence such a crystalline structure or a liquid crystalline structure can be detected directly, for example, by observation under crossed nicols of a polarization microscope, or by X-ray scattering. Further it can be detected indirectly by decrease in a temperature dependent change in the storage elastic modulus.

There is no particular restriction on the epoxy resin monomer, insofar as it is a compound having at least one mesogenic group and at least 2 epoxy groups. From an aspect of thermal conductivity, it is preferably a compound represented by the following general formula (II).

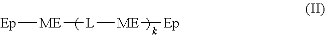

In the general formula (II), Ep represents a group including an epoxy group; ME represents a mesogenic group; and L represents a bivalent linking group respectively; and k represents 0 or 1.

Ep represents a group including an epoxy group, and is preferably a group including an epoxy group and a linking group for linking the epoxy group and a mesogenic group. As a group including an epoxy group represented by Ep according to the present invention, from aspects of preservation stability and thermal conductivity, a group including an epoxy group represented by the following general formula (IV) is preferable.

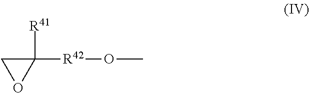

In the general formula (IV), R⁴¹ represents a hydrogen atom or an alkyl group, and R⁴² represents an alkylene group. The alkyl group for R⁴¹ is preferably an alkyl group having carbon atoms 1 to 4. The alkylene group for R⁴² is preferably an alkylene group having carbon atoms 1 to 4.

ME represents a mesogenic group. A mesogenic group according to the present invention means a functional group, which has a rigid structure as a molecular structure, has strong intermolecular force and alignment tendency, and is able to develop liquid crystallinity. Specific examples thereof include a structure linking 2 or more aromatic rings or aliphatic rings by a single bond, or a chain or cyclic linking group including an ester bond, an amide bond, an azo bond, or an unsaturated bond, and a structure containing a polycyclic aromatic.

An epoxy resin monomer according to the present invention may contain 1 mesogenic group, or contain 2 mesogenic groups.

Specific examples of a mesogenic group to be used favorably according to the present invention include the following, provided that the present invention be not limited thereto.

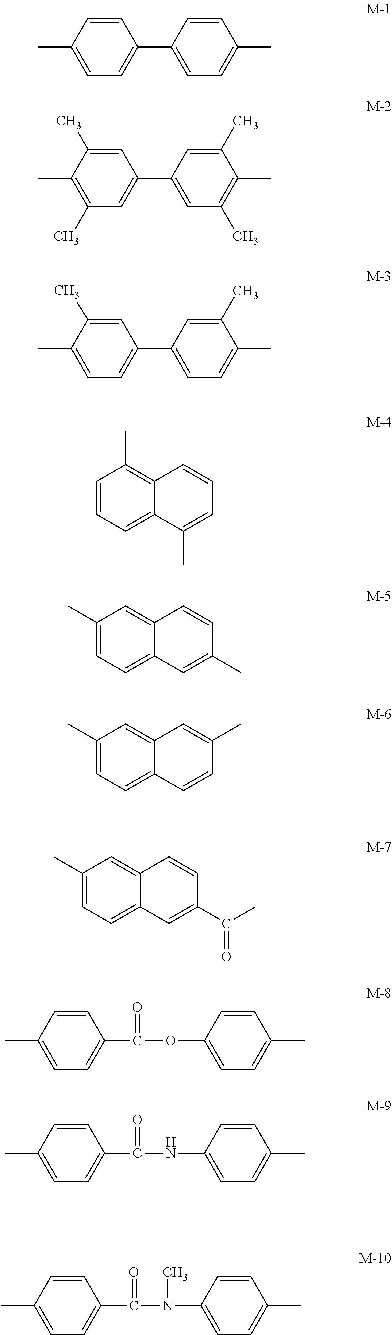

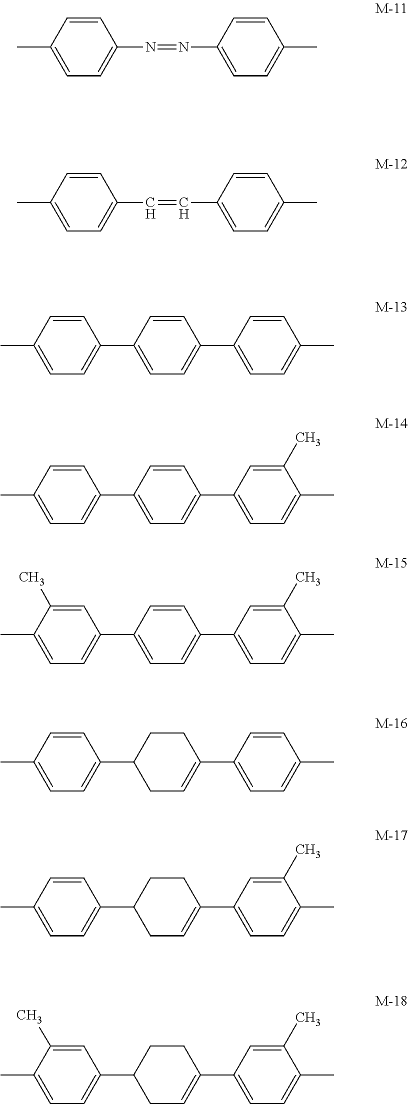

Among the specific examples of a mesogenic group shown above, from an aspect of thermal conductivity, at least one selected from M-1, M-2, M-14, M-15, M-16, and M-17 is preferable, and at least one selected from M-1, M-14, and M-17 is more preferable.

There is no particular restriction on a bivalent linking group represented by L, insofar as it can bond 2 mesogenic groups by a covalent bond. Specific examples of a bivalent linking group represented by L include the following, provided that the present invention be not limited thereto. Meanwhile, in the following specific examples, 1 represents an integer of 1 to 8.

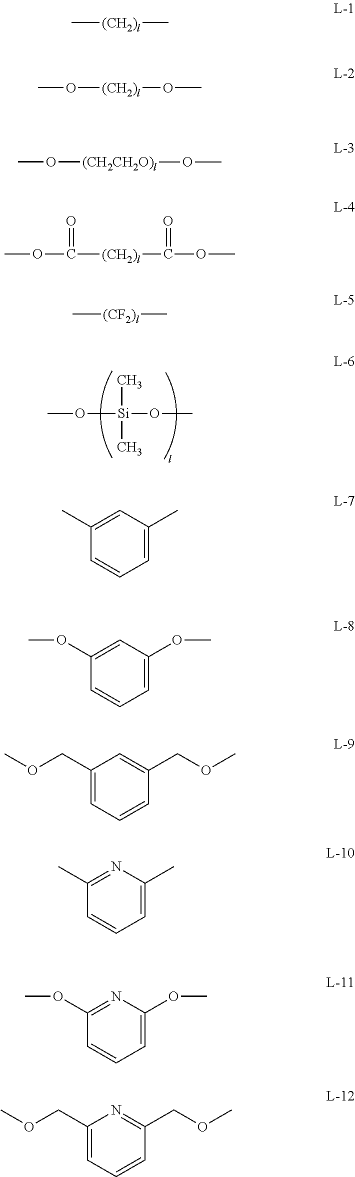

Among the specific examples of a bivalent linking group shown above, from an aspect of thermal conductivity, at least one selected out of L-2, L-3, L-9 and L-11 is preferable, and at least one selected out of L-2 and L-11 is more preferable.

As for an epoxy resin monomer according to the present invention, it is preferable that Ep in the general formula (II) is a glycidyloxy group, ME is at least one selected out of M-1, M-2, M-14, M-15, M-16 and M-17, and L is at least one selected out of L-2, L-3, L-9 and L-11; and more preferable that Ep is a glycidyloxy group, ME is at least one selected out of M-1, M-14 and M-17, and L is at least one selected out of L-2 and L-11.

Specific examples of an epoxy resin monomer, which can be used according to the present invention, are shown below, provided that the present invention be not limited thereto.

4,4′-biphenolglycidylether, 1-{(3-methyl-4-oxiranylmethoxy)phenyl}-4-(4-oxiranylmethoxyphenyl)-1-cyclohexene, 4-(oxiranylmethoxy)benzoic acid-1,8-octanediylbis(oxy-1,4-phenylene) ester, and 2,6-bis[4-[4-[2-(oxiranylmethoxy)ethoxy]phenyl]phenoxy]pyridine.

There is no particular restriction on the content percentage of the epoxy resin monomer in a resin composition according to the present invention and from an aspect of thermal conductivity 1.0 to 20% by mass with respect to the total mass of the resin composition is preferable, and from an aspect of coefficient of elasticity 3 to 15.0% by mass is more preferable.

While, with respect to the novolac resin, from an aspect of thermal conductivity, the content percentage of the epoxy resin monomer is preferably 200 to 600% by mass, and from an aspect of coefficient of elasticity, more preferably 250 to 550% by mass.

With respect to a resin composition according to the present invention, it preferably contains, as a novolac resin at least one selected from structures represented by the general formula (I); and as an epoxy resin monomer at least one selected from 4,4′-biphenolglycidylether, 1-{(3-methyl-4-oxiranylmethoxy)phenyl}-4-(4-oxiranylmethoxyphenyl)-1-cyclohexene, 4-(oxiranylmethoxy)benzoic acid-1,8-octanediylbis(oxy-1,4-phenylene) ester, and 2,6-bis[4-[4-[2-(oxiranylmethoxy)ethoxy]phenyl]phenoxy]pyridine; the content percentage (by % by mass) of the epoxy resin monomer with respect to the novolac resin is preferably 250 to 600%.

(Inorganic Filler)

A resin composition according to the present invention contains at least one inorganic filler. There is no particular restriction on the inorganic filler, insofar as it is an insulating inorganic compound, and that having high thermal conductivity is preferable.

Specific examples of an inorganic filler include aluminum oxide, magnesium oxide, boron nitride, aluminum nitride, silicon nitride, talc, mica, aluminum hydroxide, and barium sulfate. Among them, aluminum oxide, boron nitride, and aluminum nitride are preferable from an aspect of thermal conductivity. The inorganic fillers may be used singly or in a combination of 2 or more types.

Examples of particle morphology of the inorganic filler include spherical, cataclastic, scaly and aggregated particle, and as the morphology with a good packing property spherical is preferable. There is no particular restriction on the average particle size, and from aspects of thermal conductivity and formability 100 μm or less is preferable, and from aspects of formability and insulation 0.1 to 80 μm is more preferable.

In this connection, average particle size means herein volume-averaged particle size, and measured by laser diffractometry. Laser diffractometry can be conducted using a laser diffraction scattering particle size distribution analyzer (for example, LS230, by Beckman Coulter, Inc.).

The inorganic filler within the average particle size range exhibits a better packing property, if it has a broader particle size distribution. In this case, a single type exhibiting a particle size distribution with a single mode, or a single type exhibiting a particle size distribution with 2 or more modes, or a mixture thereof can be used, and an inorganic filler exhibiting a particle size distribution with 3 or more more modes in total is more preferable.

If a mixture of inorganic fillers is used, a mixture of those having discrepant average particle sizes exhibits better packing; and for example, for a trimodal particle size distribution, it is preferable to have an average particle size of 0.1 to 0.8 μm, an average particle size of 1 to 20 μm, and an average particle size of 15 to 80 μm. Using such an inorganic filler, the packing fraction of the inorganic filler improves and the thermal conductivity improves.

The content of an inorganic filler in the resin composition may be in a range of 1 to 99 parts by mass based on the total mass of an epoxy resin, a novolac resin, and an inorganic filler as 100 parts by mass, is preferably 50 to 97 parts by mass, and more preferably 70 to 95 parts by mass. If the content of an inorganic filler is in the range, higher thermal conductivity can be attained.

(Silane Coupling Agent)

A resin composition according to the present invention includes preferably at least one silane coupling agent. By inclusion of a silane coupling agent, the bond between a resin component containing an epoxy resin and a novolac resin and an inorganic filler improves, and higher thermal conductivity and stronger adhesiveness can be attained.

There is no particular restriction on the silane coupling agent, insofar as it is a compound having a functional group bonding to a resin component and a functional group bonding to an inorganic filler, and a generally used silane coupling agent can be used.

Examples of a functional group bonding to an inorganic filler include a trialkoxysilyl group, such as a trimethoxysilyl group and a triethoxysilyl group. Examples of a functional group bonding to the resin component include an epoxy group, an amino group, a mercapto group, a ureido group, and an aminophenyl group.

Specific examples of a silane coupling agent include 3-glycidoxypropyltrimethoxysilane, 3-glycidoxypropyltriethoxysilane, 3-glycidoxypropylmethyldimethoxysilane, 2-(3,4-epoxycyclohexyl)ethyltrimethoxysilane, 3-aminopropyltriethoxysilane, 3-(2-aminoethyl)aminopropyltriethoxysilane, 3-aminopropyltrimethoxysilane, 3-(2-aminoethyl)aminopropyltrimethoxysilane, 3-phenylaminopropyltrimethoxysilane, 3-mercaptotriethoxysilane, and 3-ureidopropyltriethoxysilane.

Further, a silane coupling agent oligomer represented by SC-6000KS2 (by Hitachi Chemical Coated Sand Co., Ltd.) can be used.

The silane coupling agents may be used singly or in a combination of 2 or more types.

There is no particular restriction on the content percentage of a silane coupling agent in the resin composition and from an aspect of thermal conductivity it is preferably 0.02 to 0.83% by mass based on the total mass of the resin composition, and more preferably 0.04 to 0.42% by mass.

The content percentage of a silane coupling agent with respect to an inorganic filler is, from aspects of thermal conductivity and insulation, preferably 0.02 to 1% by mass, and more preferably 0.05 to 0.5% by mass.

(Other Components)

A resin composition according to the present invention may contain in addition to the above essential components another component according to need. Examples of another component include an organic solvent, a curing accelerator, and a dispersing agent.

(Method for Producing Resin Composition)

As a method for producing a resin composition according to the present invention, a generally used method for producing a resin composition can be used without particular restriction. For example, as a method for mixing an epoxy resin, a novolac resin, an inorganic filler, and the like general dispersing machines, such as a mixer, a grinding machine, a triple roll mill, and a ball mill, can be used in an appropriate combination thereof. Further, by adding an appropriate organic solvent, dispersion and dissolution can be carried out.

It can be prepared, for example, by dissolving or dispersing an epoxy resin, a novolac resin, an inorganic filler and a silane coupling agent in an appropriate organic solvent, and mixing thereto, according to need, another component, such as a curing accelerator, and an ion trapping agent. An organic solvent is supposed to be dried up or removed at a drying step in producing a resin sheet; and if it should remain in a large amount, it would affect the thermal conductivity or the insulation property. Consequently, a solvent with the low boiling point and vapor pressure is desirable. However, if it is removed completely, the sheet will become hard and the adhesiveness will be lost; and therefore a suitable drying method and condition must be adopted. A solvent may be selected appropriately according to a resin type and a filler type to be used, as well as the easiness of drying in sheeting. Examples thereof, which can be used favorably, include alcohols, such as methanol, ethanol, 1-propanol, 2-propanol, 1-butanol, 2-propanol, and cyclohexanol, a ketone solvent, such as methyl ethyl ketone, cyclohexanone, and cyclopentanone, and a nitrogen containing solvent, such as dimethylformamide and dimethylacetamide.

<Resin Sheet>

A resin sheet according to the present invention can be yielded by forming the resin composition into a sheet form. The particulars of the resin composition are as described above. The resin sheet constituted by including the resin composition is superior in the preservation stability before curing and the thermal conductivity after curing. For producing a resin sheet in an uncured state, a technique, by which a resin composition is heated or dissolved in an organic solvent, and formed into a sheet form, is applied. The uncured state means a state in which the viscosity of a resin heated at a temperature of 200° C. is 10⁵ Pa·s or less. A resin layer after curing may be softened by heating, but the viscosity will not become 10⁵ Pa·s or less.

A support medium may be provided on either or both the surfaces of a resin sheet to protect adhesive surfaces, by which a resin composition can be protected from adhesion of a foreign matter to adhesive surfaces or an impact from the external environment.

A resin sheet according to the present invention may be a resin layer derived from the resin composition placed on a substrate. The film thickness of a resin layer may be appropriately selected according to an object, and is typically 50 μm to 500 μm, and preferably 70 μm to 300 μm from aspects of adhesive property and insulation.

Examples of a support medium include a plastic film, such as a polytetrafluoroethylene film, a polyethylene terephthalate film, a polyethylene film, a polypropylene film, a polymethylpentene film, and a polyimide film. The film may be, according to need, subjected to a surface treatment, such as primer coating, a UV treatment, a corona discharge treatment, a polishing treatment, an etching treatment, and a release agent treatment. Further, a metal, such as a copper foil and an aluminum plate, can be also used as the support medium.

While, the support medium may be placed on either of the surfaces of a resin sheet, or placed on both the surfaces.

If the support medium is a film, there is no particular restriction on the film thickness, and it may be decided appropriately according to the film thickness of a resin layer or the application of a resin sheet, based on the knowledge of those skilled in the art. From aspects of economy and handling of a resin sheet, it is preferably 10 to 150 μm, and from an aspect of handling more preferably 30 to 110 μm. When the support medium is a metal, there is no particular restriction on the thickness.

A resin sheet according to the present invention can be produced, for example, by applying the resin composition on the support medium followed by drying. There is no particular restriction on a applying method and a drying method of a resin composition, and a method usually used may be selected appropriately. Examples of a applying method include a comma coater, a slot die coater, and dip coating, and examples of a drying method include heat-drying under a normal pressure or a reduced pressure, natural drying and freeze-drying.

<Cured Resin Material and Method for Producing the Same>

A cured resin material according to the present invention can be yielded by curing the resin composition. Thereby a cured resin material with excellent thermal conductivity can be constituted.

There is no particular restriction on a curing method for a resin composition, and a generally used method can be appropriately selected. For example, a resin composition can be cured by a heat treatment to yield a cured resin material.

There is no particular restriction on a method of a heat treatment for a resin composition, or no particular restriction on a heating condition. Among others, from an aspect of achieving highest possible thermal conductivity, a step of a heat treatment in a temperature range in which a mesogenic group contained in the epoxy resin monomer develops liquid crystallinity (hereinafter occasionally referred to as “specific temperature range”) is preferably included.

The specific temperature range may be selected appropriately according to an epoxy resin monomer constituting a resin composition, and is preferably 70 to 200° C. By heat-treating in the temperature range, higher thermal conductivity can be attained. In a higher temperature range, curing proceeds too fast, and in a lower range, a resin does not melt and curing does not proceed.

There is no particular restriction on the heat treatment time in the specific temperature range, it is preferable to increase the temperature gradually within the specific temperature range. On the other hand, if the temperature is increased rapidly the temperature may go out of the specific temperature range due to the curing heat of a resin, which is unfavorable. While, by a treatment at a temperature below the range, curing does not proceed. Specifically, heating for 0.5 to 10 hours is preferable, and insofar as the workability is not impaired the longer time is more preferable.

According to the present invention in addition to a heat treatment in the specific temperature range, at least one step for a heat treatment at a higher temperature may be added. Thereby the coefficient of elasticity, the thermal conductivity, and the adhesive strength of a cured product can be improved.

Especially, from an aspect of enhancing thermal conductivity, heating in at least 2 stages of not less than 100° C. but less than 160° C., and not less than 160° C. but less than 250° C. is more preferable, and heating in at least 3 stages of not less than 100° C. but less than 160° C., not less than 160° C. but less than 190° C., and not less than 190° C. but less than 250° C. is further preferable.

The present invention is applied to a place requiring compatibly both insulation and heat dissipating property, and there is no particular restriction on an applicable device. For example, for a central processing unit of a personal computer or a semiconductor device used for controlling an electrical car motor, a heat sink or a radiation fin is indispensable, and therefore use in such application is advantageous. As an insulating material for a generally used printed substrate, an organic material has been broadly utilized. Such organic material has, however, high insulation but its thermal conductivity is low and contribution to heat dissipation of a semiconductor device is limited. Meanwhile, for heat dissipation of a semiconductor device, an inorganic material such as an inorganic ceramic is used occasionally. Such inorganic material has high thermal conductivity, but its insulation is not sufficient by any means compared to an organic material. A cured resin material obtained according to the present invention is suitable as a material satisfying both, and expected to be usable in both the applications.

<Resin Sheet Laminate and Method for Producing the Same>

A resin sheet laminate according to the present invention has a cured resin sheet obtained by curing the resin sheet and a metal plate or a radiator plate placed on at least one surface of the cured resin sheet.

Such a resin sheet laminate has high thermal conductivity, high adhesive strength between a resin layer and a metal plate or a radiator plate, and further is superior in thermal shock resistance.

Examples of a metal plate or a radiator plate include a copper plate, an aluminum plate, and a ceramic plate. While, there is no particular restriction on the thickness of a metal plate or a radiator plate. As a metal plate or a radiator plate a metal foil, such as a copper foil and an aluminum foil may be used.

The resin sheet laminate can be produced by a method for producing including a step, in which a laminate is prepared by placing a metal plate or a radiator plate on at least one surface of the resin sheet, and a step, in which the laminate is heated in a temperature range of 70° C. to 200° C.

As a method for placing a metal plate or a radiator plate on a resin sheet, a generally used method can be applied without particular restriction. An example of the method is bonding a metal plate or a radiator plate on to at least one surface of a resin sheet. Examples of a bonding method include a pressing method and a laminating method.

A method for curing a resin layer (resin sheet) of the laminate by heating, and a preferable embodiment thereof, are as described above.

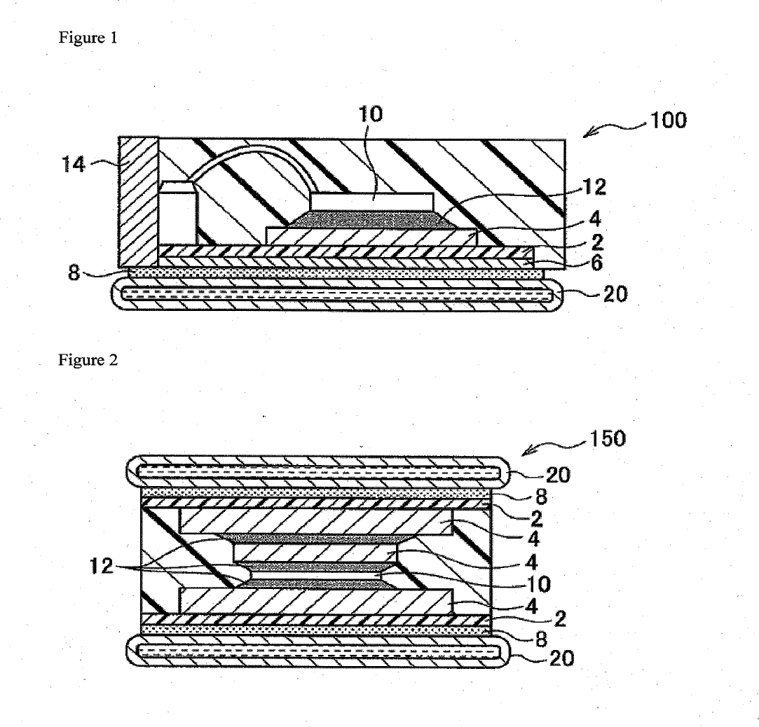

In FIG. 1 to FIG. 3, examples of a constitution of a power semiconductor device constituted by using a cured resin material according to the present invention are shown.

FIG. 1 is a schematic cross-sectional view showing an example of a constitution of a power semiconductor device 100 constituted by laminating a copper plate 4 provided with a power semiconductor chip 10 through the intermediary of a solder layer 12, a resin sheet 2 according to the present invention, and a radiating base 6 placed on a water-cooling jacket 20 through the intermediary of a grease layer 8. Since a heat generator including the power semiconductor chip 10 contacts a heat radiating member through the intermediary of the resin sheet 2 according to the present invention, efficient heat dissipation can be conducted. In this regard, the radiating base 6 can be constituted with thermally conductive copper or aluminum.

FIG. 2 is a schematic cross-sectional view showing an example of a constitution of a power semiconductor device 150 constituted by placing cooling members on both surfaces of a power semiconductor chip 10. In the power semiconductor device 150, the cooling member placed on the upper surface of the power semiconductor chip 10 is constituted by including 2 layers of copper plates 4. Due to this constitution, occurrence of chip breakage or solder fracture can be inhibited more effectively. In FIG. 2, the resin sheet 2 and the water-cooling jacket 20 are arranged through the intermediary of the grease layer 8, but the resin sheet 2 and the water-cooling jacket 20 may be arranged so as to allow direct contact between them.

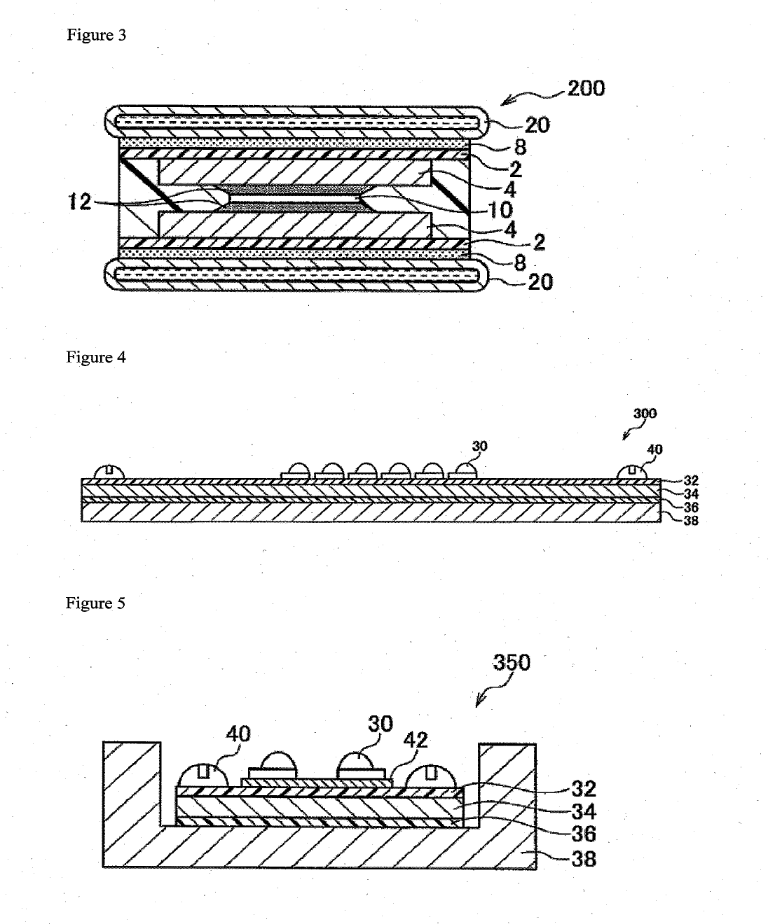

FIG. 3 is a schematic cross-sectional view showing an example of a constitution of a power semiconductor device 200 constituted by placing cooling members on both surfaces of a power semiconductor chip 10. In the power semiconductor device 200, the cooling members placed on both the surfaces of the power semiconductor chip 10 are constituted by each including 1 layer of copper plate 4. In FIG. 3, the resin sheet 2 and the water-cooling jacket 20 are arranged through the intermediary of the grease layer 8, but the the resin sheet 2 and the water-cooling jacket 20 may be arranged so as to allow direct contact between them.

FIG. 4 is a schematic cross-sectional view showing an example of a constitution of an LED light bar 300 constituted with a cured resin material according to the present invention. The LED light bar 300 is constituted by arranging a housing 38, a grease layer 36, an aluminum substrate 34, a resin sheet 32 according to the present invention, and LED chips 30 in the order mentioned. By placing heat generators, namely the LED chips 30, on the aluminum substrate 34 through the intermediary of the resin sheet 32 according to the present invention, heat dissipation can be conducted efficiently.

FIG. 5 is a schematic cross-sectional view showing an example of a constitution of a light emitting section 350 of an LED bulb. The light emitting section 350 of the LED bulb is constituted by arranging a housing 38, a grease layer 36, an aluminum substrate 34, a resin sheet 32 according to the present invention, a circuit layer 42 and LED chips 30 in the order mentioned.

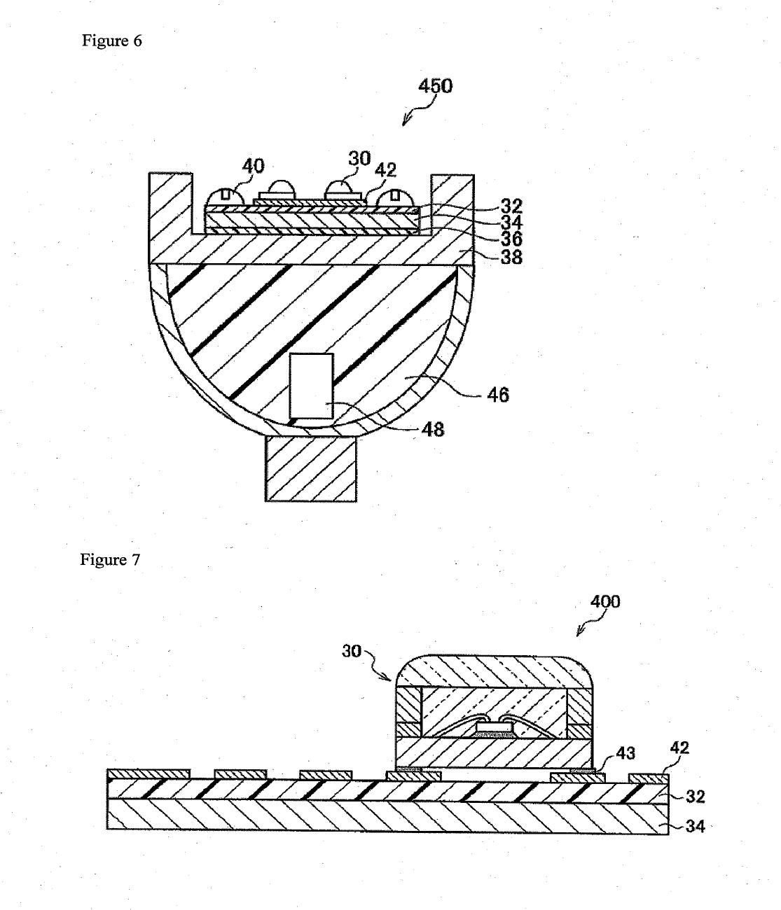

Further, FIG. 6 is a schematic cross-sectional view showing an example of an overall constitution of an LED bulb 450.

FIG. 7 is a schematic cross-sectional view showing an example of a constitution of an LED substrate 400. The LED substrate 400 is constituted by arranging an aluminum substrate 34, a resin sheet 32 according to the present invention, a circuit layer 42, and an LED chip 30 in the order mentioned. By placing heat a generator, namely the LED chip 30, on the aluminum substrate 34 through the intermediary of the circuit layer and the resin sheet 32 according to the present invention, heat dissipation can be conducted efficiently.

The disclosures of Japanese Patent Application No. 2009-224333 and Japanese Patent Application No. 2010-071002 are incorporated by reference herein in their entireties.

All the literature, patent applications, and technical standards cited herein are also herein incorporated to the same extent as provided for specifically and severally with respect to an individual literature, patent application, and technical standard to the effect that the same should be so incorporated by reference.

### EXAMPLES

Specific examples of the present invention will be described below by way of Examples, provided that the present invention be not limited thereto. Unless otherwise specified herein “part” and “%” are in terms of mass.

Types and codes of an epoxy resin monomer, a novolac resin, an inorganic filler, an additive, and a solvent appeared in Examples are shown below. Meanwhile, for a synthesis method for an epoxy resin monomer were used Japanese Patent Laid-Open No. 2005-206814 and Japanese Patent Laid-Open No. 2005-29778 as reference.

(Epoxy Resin Monomer)

BPGE: 4,4′-biphenol glycidyl ether;
MOPOC: 1-{(3-methyl-4-oxiranylmethoxy)phenyl}-4-(4-oxiranylmethoxyphenyl)-1-cyclohexene;
OAOE: 4-(oxiranylmethoxy)benzoic acid-1,8-octanediylbis(oxy-1,4-phenylene) ester; and
BOE3P: 2,6-bis[4-[4-[2-(oxiranylmethoxy)ethoxy]phenyl]phenoxy]pyridine.

(Curing Agent)

CRN1 to CRN6: catechol resorcinol novolac resins (50% content in cyclohexanone (CHN))

Japanese Patent Laid-Open No. 2006-131852, and Japanese National Publication of International Patent Application No. 2010-518183 were used as a reference for a method for producing the catechol resorcinol novolac resins. The monomer contents and the number average molecular weights are shown in Table 1.

TABLE 1

| | monomer | number average |
|---|---|---|
| | contents (%) | molecular weight |
| CRN1 | 5 | 733 |
| CRN2 | 20 | 554 |
| CRN3 | 27 | 484 |
| CRN4 | 38 | 425 |
| CRN5 | 50 | 306 |
| CRN6 | 67 | 272 |
| CRN7 | 80 | 246 |

PN: phenol novolac resin (Grade number HP850N, number average molecular weight 630, by Hitachi Chemical Co., Ltd.);
CN: catechol novolac resin (Number average molecular weight 450; 50% content in cyclohexanone); and
DAN: 1,5-diaminonaphthalene (by Air Water Inc.).

(Inorganic filler)

Aluminum oxide mixture [α-alumina by Sumitomo Chemical Co., Ltd.: mixture of aluminum oxide with the average particle size of 18 μm (AA-18) 166.80 parts, aluminum oxide with the average particle size of 3 μm (AA-3) 31.56 parts, and aluminum oxide with the average particle size of 0.4 μm (AA-04) 27.05 parts]

(Additive)

TPP: triphenylphosphine (by Wako Pure Chemical Industries, Ltd.); and
PAM: 3-phenylaminopropyltrimethoxysilane (KBM-573, by Shin-Etsu Chemical Co., Ltd.).

(Solvent)

MEK: methyl ethyl ketone; and
CHN: cyclohexanone.

### (Support Medium)

PET film: (75E-0010CTR-4, by Fujimori Kogyo Co., Ltd.); and
Copper foil: GTS Grade: thickness 80 μm, by Furukawa Electric Co., Ltd.

### Example 1

(Production of Resin Sheet)

An aluminum oxide mixture 225.41 parts, a silane coupling agent PAM 0.24 part, as a novolac resin a CHN solution of CRN1 with the monomer content of 5% (solid content 50%; by Hitachi Chemical Co., Ltd.) 11.33 parts, MEK 37.61 parts and CHN 6.70 parts were mixed. After confirming that they were mixed uniformly, as an epoxy resin monomer, MOPOC 16.99 parts and TPP 0.19 part were additionally mixed therein and ball-milling was continued for 40 to 60 hours to obtain as a resin composition a resin sheet coating liquid.

The obtained resin sheet coating liquid was applied on a releasing surface of a PET film as a support medium using a table coater and using an applicator to the thickness of approx. 220 μm. After being left standing at room temperature under a normal pressure for 15 min, the film was dried in a box-type oven set at 100° C. for 30 min to remove an organic solvent.

On conducting a planarization treatment by a heat press (heat plate 130° C.; pressure 1 MPa; press time 1 min), a cover film which is a PET film (75E-0010CTR-4, by Fujimori Kogyo Co., Ltd.) was simultaneously attached to the surface opposite to the surface with the substrate to obtain a sheet in a B-stage as a resin sheet with a 200 μm-thick resin composition layer.

Removing PET films from both the surfaces of the obtained B-stage sheet and covering both the surfaces with 80 μm-thick copper foils (GTS grade, by Furukawa Electric Co., Ltd.), the sheet was subjected to vacuum heat pressing (heat plate temperature 150° C., degree of vacuum ≦1 kPa, pressure 4 MPa, and processing time 10 min). Then it was cured stepwise in a box type oven at 140° C. for 2 hours, at 165° C. for 2 hours, and at 190° C. for 2 hours, to obtain a cured resin material in a form of a sheet provided with copper foils on both the surfaces.

From the obtained cured resin sheet only copper was removed by etching with a sodium persulfate solution to obtain a cured resin material in a sheet form.

### Example 2

Except that CRN2 with the the monomer content of 20% was used as a novolac resin in place of CRN1 with the the monomer content of 5% in Example 1, identically as in Example 1 were produced a resin composition, a resin sheet, and a cured resin material.

### Example 3

Except that CRN3 with the the monomer content of 27% was used as a novolac resin in place of CRN1 with the the monomer content of 5% in Example 1, identically as in Example 1 were produced a resin composition, a resin sheet, and a cured resin material.

### Example 4

Except that CRN4 with the the monomer content of 38% was used as a novolac resin in place of CRN1 with the the monomer content of 5% in Example 1, identically as in Example 1 were produced a resin composition, a resin sheet, and a cured resin material.

### Example 5

Except that CRN5 with the the monomer content of 50% was used as a novolac resin in place of CRN1 with the the monomer content of 5% in Example 1, identically as in Example 1 were produced a resin composition, a resin sheet, and a cured resin material.

### Example 6

Except that CRN6 with the the monomer content of 67% was used as a novolac resin in place of CRN1 with the the monomer content of 5% in Example 1, identically as in Example 1 were produced a resin composition, a resin sheet, and a cured resin material.

### Example 7

Except that CRN7 with the the monomer content of 80% was used as a novolac resin in place of CRN1 with the the monomer content of 5% in Example 1, identically as in Example 1 were produced a resin composition, a resin sheet, and a cured resin material.

### Example 8

Except that BPGE 19.56 g was used as an epoxy resin monomer in place of MOPOC and the amount of a novolac resin was changed to 8.64 g in Example 2, identically as in Example 2 were produced a resin composition, a resin sheet, and a cured resin material.

### Example 9

Except that BOE3P 16.88 g was used as an epoxy resin monomer in place of MOPOC and the amount of a novolac resin was changed to 13.95 g in Example 2, identically as in Example 2 were produced a resin composition, a resin sheet, and a cured resin material.

### Example 10

Except that OAOE 20.22 g was used as an epoxy resin monomer in place of MOPOC and the amount of a novolac resin was changed to 7.32 g in Example 2, identically as in Example 2 were produced a resin composition, a resin sheet, and a cured resin material.

### Comparative Example 1

An aluminum oxide mixture 225.41 parts, a silane coupling agent PAM 0.24 part, as a novolac resin PN 8.92 parts, MEK 37.61 parts, CHN 6.70 parts and alumina balls 300.00 parts (particle size 10 mm) were mixed. After confirming that they were mixed uniformly, as an epoxy resin, MOPOC 8.92 parts and TPP 0.19 part were additionally mixed therein and ball-milling was continued for 40 to 60 hours to obtain as a resin composition a resin sheet coating liquid.

Except that the thus obtained resin sheet coating liquid was used, identically as in Example 1 were produced a resin sheet, and a cured resin material.

### Comparative Example 2

An aluminum oxide mixture 225.41 parts, a silane coupling agent PAM 0.24 part, as a novolac resin a CHN solution of CN (solid content 50%, by Hitachi Chemical Co., Ltd.) 11.33 parts, MEK 37.61 parts, CHN 6.70 parts and alumina balls 300.00 parts (particle size 10 mm) were mixed. After confirming that they were mixed uniformly, as an epoxy resin, MOPOC 8.92 parts and TPP 0.19 part were additionally mixed therein and ball-milling was continued for 40 to 60 hours to obtain as a resin composition a resin sheet coating liquid.

Except that the thus obtained resin sheet coating liquid was used, identically as in Example 1 were produced a resin sheet, and a cured resin material.

### Comparative Example 3

An aluminum oxide mixture 225.41 parts, a silane coupling agent PAM 0.24 part, as a curing agent DAN 3.71 parts, MEK 37.61 parts, CHN 6.70 parts and alumina balls 300.00 parts (particle size 10 mm) were mixed. After confirming that they were mixed uniformly, as an epoxy resin, MOPOC 8.92 parts and TPP 0.19 part were additionally mixed therein and ball-milling was continued for 40 to 60 hours to obtain as a resin composition a resin sheet coating liquid.

Except that the thus obtained resin sheet coating liquid was used, identically as in Example 1 were produced a resin sheet, and a cured resin material.

### Comparative Example 4

Except that BPGE 10.83 g was used as an epoxy resin monomer in place of MOPOC and the amount of 1,5-DAN was changed to 1.80 g in Comparative Example 3, identically as in Comparative Example 3 were produced a resin composition, a resin sheet, and a cured resin material.

### Comparative Example 5

Except that BOE3P 11.05 g was used as an epoxy resin monomer in place of MOPOC and the amount of 1,5-DAN was changed to 1.58 g in Comparative Example 3, identically as in Comparative Example 3 were produced a resin composition, a resin sheet, and a cured resin material.

### Comparative Example 6

Except that OAOE 12.01 g was used as an epoxy resin monomer in place of MOPOC and the amount of 1,5-DAN was changed to 0.61 g in Comparative Example 3, identically as in Comparative Example 3 were produced a resin composition, a resin sheet, and a cured resin material.

<Evaluation Method>

With respect to a resin composition produced as above, the usable life of a resin composition, the thermal conductivity, the insulation breakdown voltage, and the peel strength of a cured resin material formed with the resin composition were evaluated. The results are shown in Table 2,

(Measuring Method for Thermal Conductivity)

Thermal conductivity was determined using the heat conduction equation as the product of respectively measured values of density, specific heat and thermal diffusivity.

First, a measuring method of thermal diffusivity will be described below. From a obtained cured resin sheet provided with copper foils, only copper was removed by etching with a sodium persulfate solution to obtain a cured resin material in a sheet form. The thermal diffusivity of the obtained cured resin material was measured using Nanoflash LFA447 Model (by NETZSCH) by a flash lamp method.

The density was determined similarly using a cured sheet removed of copper foils by the Archimedean method. Further, the specific heat was determined using a differential thermal analyzer (DSC) (Pyris 1 Model, by Parkin Elmer) from difference in heat input.

(Measuring Method for Insulation Breakdown Voltage)

From a cured resin sheet only copper was removed by etching with a sodium persulfate solution to obtain a cured resin material in a sheet form. The insulation breakdown voltage of the obtained cured resin material was measured by YST-243-100RHO (by Yamayo Measuring Tools Co., Ltd.) using copper plate electrodes at room temperature in the atmosphere.

(Measuring Method for Peel Strength)

A cured resin sheet provided with copper foils on both the surfaces was cut into a size of 25 mm×100 mm and lined with a resin plate, from which copper foils were peeled off to 10 mm width to prepare a sample sheet. The peel strength was measured using Autograph AGG-100 Model (by Shimadzu Corporation) by pulling the copper foil vertically from the sample sheet.

(Measuring Method for Usable Life)

A 200 μm-thick resin composition (B-stage sheet) was stored and subjected to change over time at room temperature for a predetermined time, then it was pressed to bend around a cylinder with the radius of 20 mm, and the usable life was judged by observing whether it could be bent without generating a crack.

TABLE 2

| | | | thermal | | | insulation | peel |
|---|---|---|---|---|---|---|---|
| | | curing | conductivity | | | breakdown | strength |
| | epoxy resin | agent | (W/mK) | usable life | | voltage (kV) | (kN/m) |
| example 1 | MOPOC | CRN1 | 8.8 | ≧2 | weeks | 5.6 | 0.9 |
| example 2 | MOPOC | CRN2 | 9.5 | ≧2 | weeks | 5.0 | >1.2 |
| example 3 | MOPOC | CRN3 | 9.3 | ≧2 | weeks | 5.7 | >1.2 |
| example 4 | MOPOC | CRN4 | 9.4 | ≧2 | weeks | 6.5 | 1.1 |
| example 5 | MOPOC | CRN5 | 9.8 | ≧2 | weeks | 7.9 | 0.9 |
| example 6 | MOPOC | CRN6 | 8.6 | ≧2 | weeks | 6.4 | 1.0 |
| example 7 | MOPOC | CRN7 | 8.6 | ≧2 | weeks | 6.7 | 1.0 |
| example 8 | BPGE | CRN2 | 5.3 | ≧2 | weeks | 4.2 | 1.2 |
| example 9 | BOE3P | CRN2 | 4.8 | ≧2 | weeks | 3.7 | 1.0 |
| example 10 | OAOE | CRN2 | 7.8 | ≧2 | weeks | 4.3 | 1.1 |
| comparative | MOPOC | PN | 5.1 | ≧2 | weeks | 3.2 | >1.2 |
| example 1 | | | | | | | |
| comparative | MOPOC | CN | 6.2 | ≧2 | weeks | 4.2 | >1.2 |
| example 2 | | | | | | | |
| comparative | MOPOC | DAN | 9.3 | 1 | hour | 2.0 | 1.0 |
| example 3 | | | | | | | |
| comparative | BPGE | DAN | 5.2 | 5 | hour | 1.5 | 0.8 |
| example 4 | | | | | | | |
| comparative | BOE3P | DAN | 4.5 | 3 | hour | 1.4 | 0.5 |
| example 5 | | | | | | | |
| comparative | OAOE | DAN | 9.3 | 1 | hour | 2.0 | 1.0 |
| example 6 | | | | | | | |

From Table 2 is obvious that a resin composition according to the present invention has long usable life, and is superior in preservation stability. Further, it is also obvious that a cured resin material formed with a resin composition according to the present invention has high thermal conductivity, is superior in insulation, and has high peel strength.

### INDUSTRIAL APPLICABILITY

A resin composition according to the present invention has long usable life, and is superior in preservation stability. Further, a cured resin material formed with a resin composition according to the present invention has high thermal conductivity, is superior in insulation, and has high peel strength. Consequently, expansion in a radiating material for an inverter of a hybrid car, a radiating material for an inverter of industrial devices, and a radiating material for an LED can be expected.

### EXPLANATION OF LETTERS OR NUMERALS

2 RESIN SHEET
4 COPPER PLATE
6 RADIATING BASE
8 GREASE LAYER
10 POWER SEMICONDUCTOR CHIP
12 SOLDER LAYER
14 HOUSING
30 LED CHIP
32 RESIN SHEET
34 ALUMINUM SUBSTRATE
36 GREASE LAYER
38 HOUSING (CHASSIS)
40 FIXING CLINCHER
42 CIRCUIT LAYER
43 SOLDER LAYER
46 ENCAPSULATION RESIN
48 POWER MEMBER
100 POWER SEMICONDUCTOR DEVICE
150 POWER SEMICONDUCTOR DEVICE
200 POWER SEMICONDUCTOR DEVICE
300 LED LIGHT BAR
350 LIGHT EMITTING SECTION
400 LED SUBSTRATE
450 LED BULB

1-12. (canceled)

13. A power semiconductor device, comprising:
a cooling unit;
a radiating base arranged on the cooling unit;
a resin sheet arranged on the radiating base;
a copper plate arranged on the resin sheet; and
a power semiconductor chip arranged on the copper plate via a solder layer,
wherein the resin sheet comprises a cured product of a resin composition, the resin composition comprising:
an epoxy resin monomer having a mesogenic group;
a novolac resin containing a compound having a resorcinol structural unit represented by the following Formula (I); and
an inorganic filler, 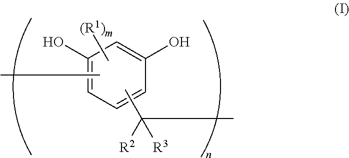
wherein R¹ represents a hydrogen atom, an alkyl group, an aryl group, or an aralkyl group; each of R² and R³ independently represents a hydrogen atom, an alkyl group, an aryl group, or an aralkyl group; m represents an integer from 0 to 2; and n represents an integer from 1 to 7.

14. The power semiconductor device according to claim 13, wherein a monomer content of the novolac resin is from 5% by mass to 80% by mass.

15. The power semiconductor device according to claim 13, wherein the epoxy resin monomer is represented by the following Formula (II): 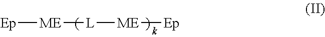
wherein Ep represents a group including an epoxy group; ME represents a mesogenic group; L represents a bivalent linking group; and k represents 0 or 1.

16. The power semiconductor device according to claim 15, wherein the ME represents a mesogenic group selected from the group consisting of M-1 to M-18:

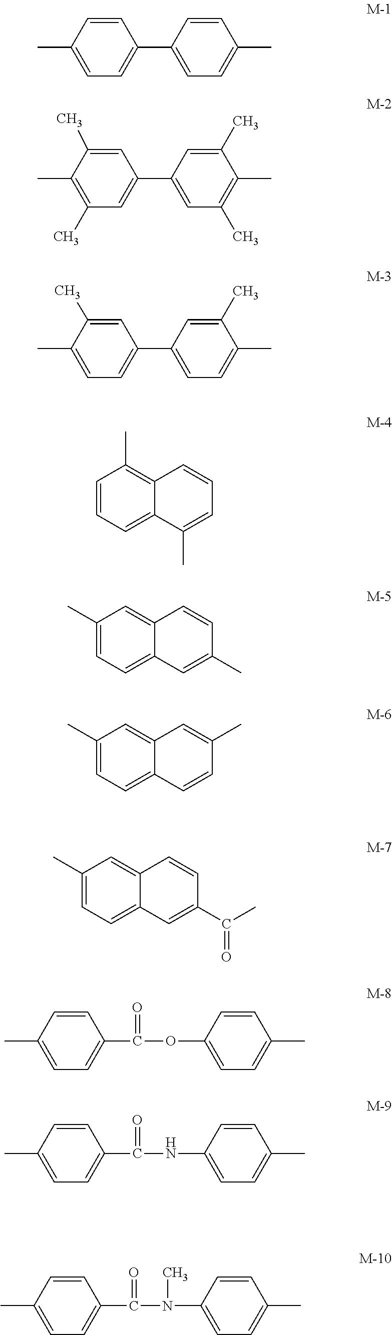

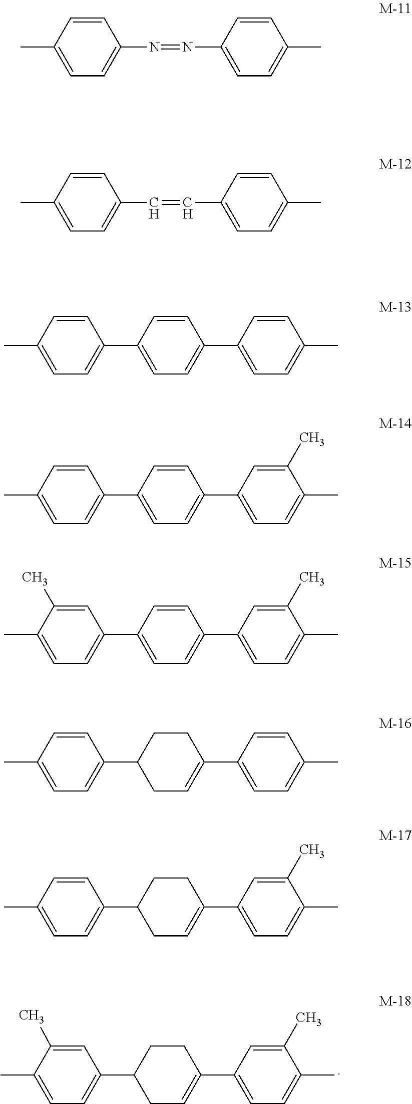

17. The power semiconductor device according to claim 13, wherein the novolac resin further comprises a phenolic structural unit derived from a phenolic compound, other than the resorcinol structural unit.

18. The power semiconductor device according to claim 13, wherein the resin composition further comprises a coupling agent.

19. A power semiconductor device, comprising:
a first cooling unit;
a first resin sheet arranged on the first cooling unit;
a first copper plate arranged on the first resin sheet;
a power semiconductor chip arranged on the first copper plate via a first solder layer;
a second copper plate arranged on the power semiconductor chip via a second solder layer;
a third copper plate arranged on the second copper plate via a third solder layer;
a second resin sheet arranged on the third copper plate; and
a second cooling unit arranged on the second resin sheet,
wherein each of the first resin sheet and the second resin sheet comprises a cured product of a resin composition, the resin composition comprising:
an epoxy resin monomer having a mesogenic group;
a novolac resin containing a compound having a resorcinol structural unit represented by the following Formula (I); and
an inorganic filler, 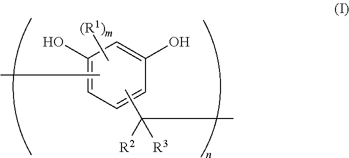
wherein R¹ represents a hydrogen atom, an alkyl group, an aryl group, or an aralkyl group; each of R² and R³ independently represents a hydrogen atom, an alkyl group, an aryl group, or an aralkyl group; m represents an integer from 0 to 2; and n represents an integer from 1 to 7.

20. The power semiconductor device according to claim 19, wherein a monomer content of the novolac resin is from 5% by mass to 80% by mass.

21. The power semiconductor device according to claim 19, wherein the epoxy resin monomer is represented by the following Formula (II): 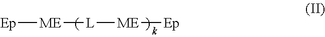
wherein Ep represents a group including an epoxy group; ME represents a mesogenic group; L represents a bivalent linking group; and k represents 0 or 1.

22. The power semiconductor device according to claim 21, wherein the ME represents a mesogenic group selected from the group consisting of M-1 to M-18:

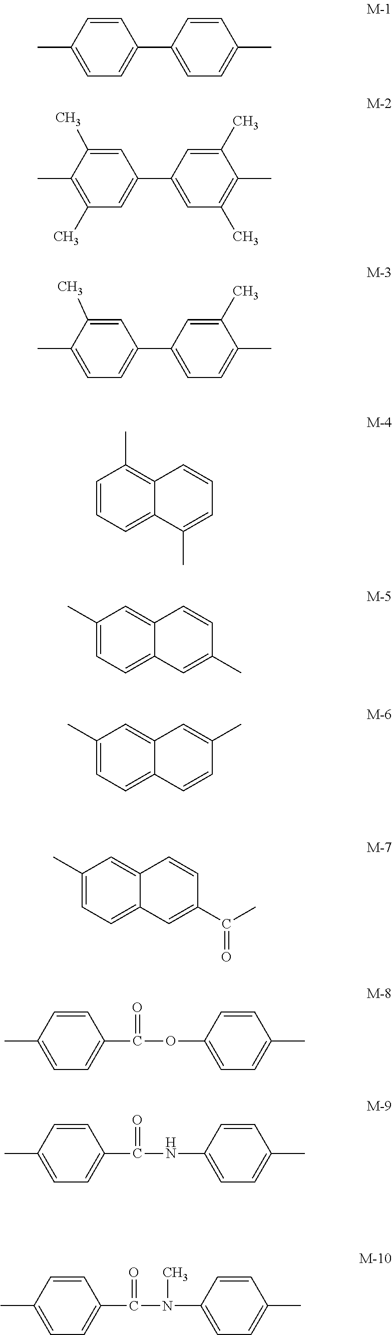

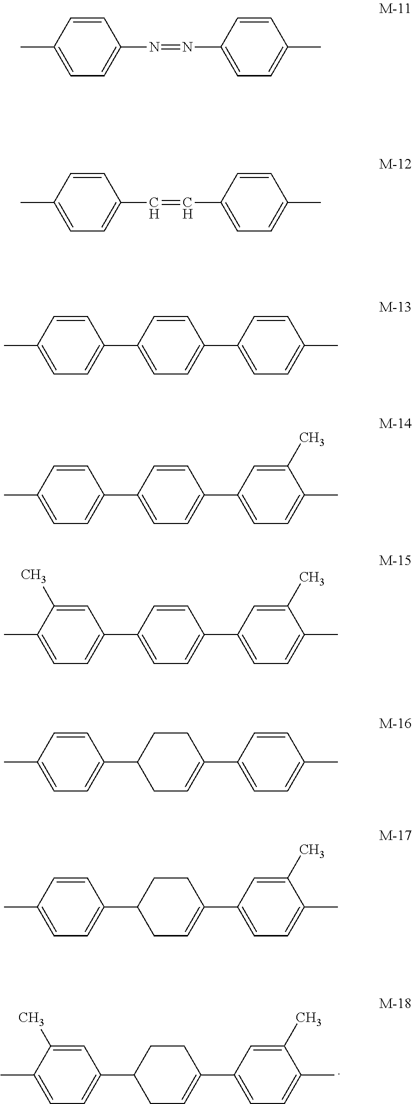

23. The power semiconductor device according to claim 19, wherein the novolac resin further comprises a phenolic structural unit derived from a phenolic compound, other than the resorcinol structural unit.

24. The power semiconductor device according to claim 19, wherein the resin composition further comprises a coupling agent.

25. A power semiconductor device, comprising:
a first cooling unit;
a first resin sheet arranged on the first cooling unit;
a first copper plate arranged on the first resin sheet;
a power semiconductor chip arranged on the first copper plate via a first solder layer;
a second copper plate arranged on the power semiconductor chip via a second solder layer;
a second resin sheet arranged on the second copper plate; and
a second cooling unit arranged on the second resin sheet,
wherein each of the first resin sheet and the second resin sheet comprises a cured product of a resin composition, the resin composition comprising:
an epoxy resin monomer having a mesogenic group;
a novolac resin containing a compound having a resorcinol structural unit represented by the following Formula (I); and
an inorganic filler, 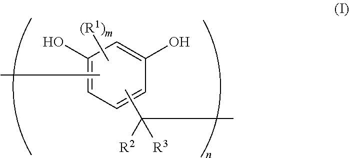
wherein R¹ represents a hydrogen atom, an alkyl group, an aryl group, or an aralkyl group; each of R² and R³ independently represents a hydrogen atom, an alkyl group, an aryl group, or an aralkyl group; m represents an integer from 0 to 2; and n represents an integer from 1 to 7.

26. The power semiconductor device according to claim 25, wherein a monomer content of the novolac resin is from 5% by mass to 80% by mass.

27. The power semiconductor device according to claim 25, wherein the epoxy resin monomer is represented by the following Formula (II): 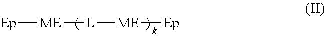
wherein Ep represents a group including an epoxy group; ME represents a mesogenic group; L represents a bivalent linking group; and k represents 0 or 1.

28. The power semiconductor device according to claim 27, wherein the ME represents a mesogenic group selected from the group consisting of M-1 to M-18:

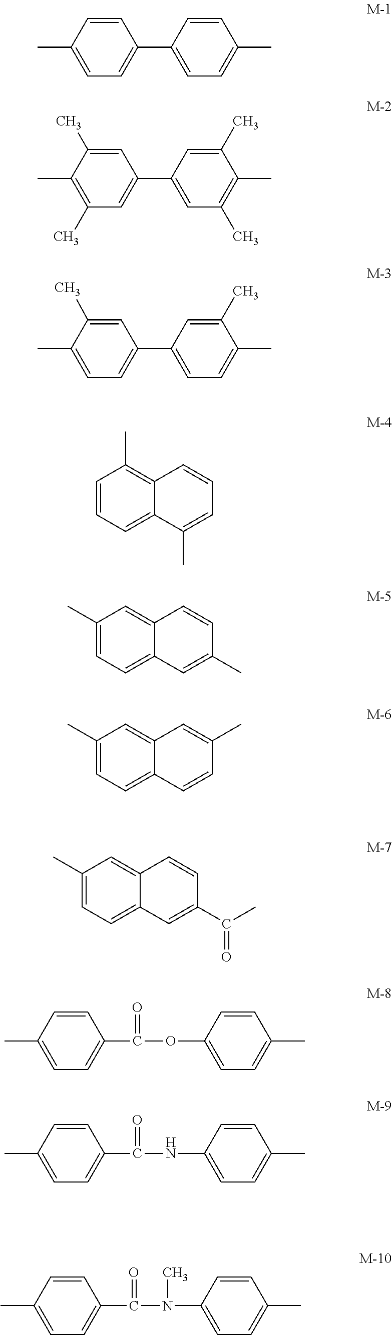

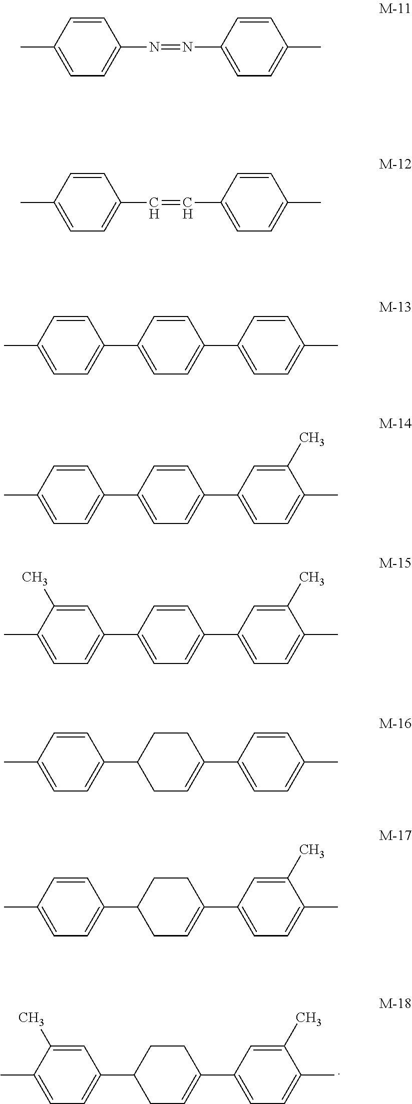

29. The power semiconductor device according to claim 25, wherein the novolac resin further comprises a phenolic structural unit derived from a phenolic compound, other than the resorcinol structural unit.

30. The power semiconductor device according to claim 25, wherein the resin composition further comprises a coupling agent.
